(19) United States
(12) Patent Application Publication
(10) Pub. No.: US 2024/0127726 A1
(43) Pub. Date: Apr. 18, 2024

(54) DISPLAY CONTROL DEVICE

(71) Applicant: NTT DOCOMO, INC., Chiyoda-ku (JP)

(72) Inventors: Yasuo MORINAGA, Chiyoda-ku (JP); Nozomi MATSUMOTO, Chiyoda-ku (JP); Hiroyuki FUJINO, Chiyoda-ku (JP); Tatsuya NISHIZAKI, Chiyoda-ku (JP); Reo MIZUTA, Chiyoda-ku (JP); Yuki NAKAMURA, Chiyoda-ku (JP)

(73) Assignee: NTT DOCOMO, INC., Chiyoda-ku (JP)

(21) Appl. No.: 18/547,352

(22) PCT Filed: Feb. 22, 2022
(86) PCT No.: PCT/JP2022/007373

§ 371 Date: Aug. 22, 2023

(30) Foreign Application Priority Data
Mar. 22, 2021 (JP) 2021-047458

(51) Int. Cl. G09G 3/00; G06T 7/70

(52) U.S. Cl. CPC G09G 3/001; G06T 7/70; G06T 2207/30201; G09G 2340/0464

(57) ABSTRACT

A display control device for performing control on a display of a display configured to display an image of content laid out in a virtual space as viewed from a predetermined position, the display being mounted on portions of eyes by a user. The device detects an orientation, with respect to the display, of a head portion of a person other than the user and determines whether a position of the content needs to be changed based on a detection-result and the position of the content in the virtual space. A position change destination of the content in the virtual space is set based on a distance between the position change destination of the content in the virtual space and a position at a current point in time of the content and to change the position of the content when the position of the content is to be changed.

### TECHNICAL FIELD

The present invention relates to a display control device that performs control on a display of a display.

### BACKGROUND ART

In the related art, a technology has been proposed to prevent a person around a user from becoming confused when displaying content on a display that the user wears on an eye portion. For example, Patent Literature 1 discloses changing a display position of information displayed on a transmissive head mounted display or the like so that a line of sight of the user does not overlap a line of sight of a nearby person.

### CITATION LIST

### Patent Literature

[Patent Literature 1] Japanese Unexamined Patent Publication No. 2006-99216

### SUMMARY OF INVENTION

### Technical Problem

As described above, a display position of the content on the display is controlled so that a person around the user can be prevented from becoming confused. Here, content is laid out in a virtual space, as in an augmented reality (AR) display in a see-through glass, and an image of the virtual space as viewed from a predetermined position in the space is displayed on the display. In such display, usually, the position of the content in the virtual space is controlled so that the display position of the content on the display is controlled. Therefore, in such a display, the technology for controlling the position of content on a plane cannot be used. Further, for example, when change in the position of the content on the display is small while the position of the content is changed in the virtual space, an orientation of the line of sight of the user does not change sufficiently, and it is not possible to prevent the line of sight of the user from overlapping the line of sight of the nearby person. For example, when the position of the content on the display greatly changes, an orientation of a face of the user may greatly change. In this case, it is possible to prevent the line of sight of the user from overlapping the line of sight of the nearby person, but there is concern that the nearby person may be suspicious. Thus, with an existing technology, the person around the user cannot be always prevented from being confused because the display position of the content is not appropriately changed in the display using the virtual space.

An embodiment of the present invention has been made in view of the above and an object of the embodiment of the present invention is to provide a display control device capable of appropriately preventing a person around a user from being confused when content located in a virtual space is displayed in a display that the user wears on an eye portion.

### Solution to Problem

In order to achieve the above object, a display control device according to an embodiment of the present invention is a display control device for performing control of a display of a display configured to display an image of content laid out in a virtual space as viewed from a predetermined position, the display being mounted on portions of eyes by a user, the display control device including: a detection unit configured to detect an orientation of at least a portion of a head portion of a person other than the user, the orientation being an orientation with respect to the display; a determination unit configured to determine whether or not a position of the content needs to be changed on the basis of a detection result by the detection unit and the position of the content laid out in the virtual space; and a position changing unit configured to set a position change destination of the content in the virtual space on the basis of a distance between the position change destination of the content in the virtual space and a position at a current point in time of the content and change the position of the content when the determination unit determines that the position of the content is to be changed.

In the display control device according to the embodiment of the present invention, the position change destination of the content is set on the basis of a distance between the position change destination of the content and a position at a current point in time in the virtual space, and the position of the content is changed. With such a configuration, the position change destination of the content is appropriately set on the basis of the distance between the position change destination of the content and the position at the current point in time. This makes it possible to prevent the line of sight of the user from overlapping a line of sight of a nearby person, and to prevent the nearby person from being suspicious due to a movement of the user. Thus, with the display control device according to the present embodiment, it is possible to prevent the person around the user from being confused.

### Advantageous Effects of Invention

According to an embodiment of the present invention, it is possible to appropriately prevent a person around a user from being confused when content located in a virtual space is displayed in a display that the user wears on an eye portion.

### BRIEF DESCRIPTION OF DRAWINGS

FIG. 1 is a diagram illustrating a configuration of a see-through glass, which is a display control device according to an embodiment of the present invention.

FIG. 2 is a diagram illustrating an example of display control in the see-through glass.

FIG. 3 is a diagram illustrating information used in the see-through glass.

FIG. 4 is a diagram illustrating an example of display control in the see-through glass.

FIG. 5 is a diagram illustrating an example of display control in the see-through glass.

FIG. 6 is a diagram illustrating information used in the see-through glass.

FIG. 7 is a diagram illustrating information used in the see-through glass.

FIG. 8 is a diagram illustrating an example of display control in the see-through glass.

FIG. 9 is a diagram illustrating an example of display control in the see-through glass.

FIG. 10 is a flowchart illustrating processing that is executed by a see-through glass, which is the display control device according to the embodiment of the present invention.

FIG. 11 is a diagram illustrating a hardware configuration of the see-through glass, which is the display control device according to the embodiment of the present invention.

### DESCRIPTION OF EMBODIMENTS

Hereinafter, an embodiment of a display control device according to the present invention will be described in detail along with the drawings. In the description of the drawings, the same reference signs are denoted by the same reference signs, and repeated description is omitted.

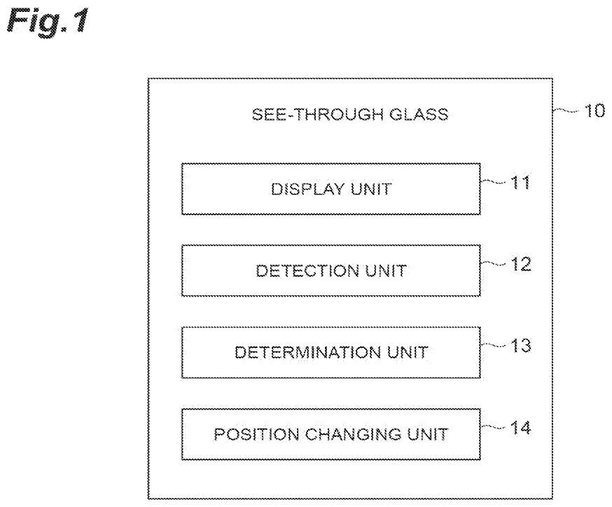

FIG. 1 illustrates a see-through glass 10 that is a display control device according to the present embodiment. The see-through glass 10 is a display that is used by being mounted on portions of eyes of the user, and that displays information to the user wearing the see-through glass. The see-through glass 10 is also a device that controls a display of the see-through glass 10. The see-through glass 10 is, for example, a transmissive head mounted display. The display control device may be, for example, a non-transmissive head mounted display instead of the see-through glass 10. Further, the display control device may be, for example, a goggles type or may be an eyeglass type.

Information displayed on the see-through glass 10 is an image of content laid out in a virtual space as viewed from a predetermined position. The virtual space in the present embodiment is a three-dimensional virtual space. Dimensions of the virtual space may not be three-dimensional. The image is displayed by the see-through glass 10 to be superimposed on a field of view of the user in a real space. For example, the see-through glass 10 is an AR glass or a mixed reality (MR) glass.

Next, a function of the see-through glass 10 according to the present embodiment will be described. As illustrated in FIG. 1, the see-through glass 10 includes a display unit 11, a detection unit 12, a determination unit 13, and a position changing unit 14.

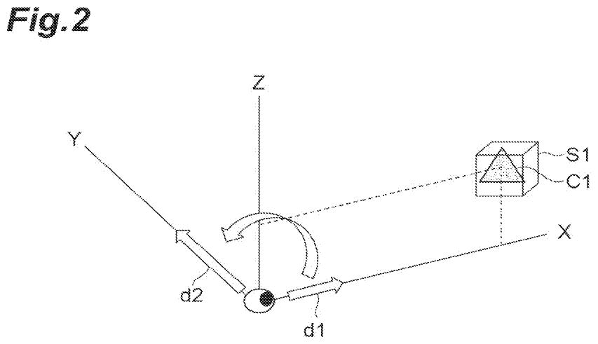

The display unit 11 acquires content from a database or the like connected to the see-through glass 10. The display unit 11 stores the acquired content in a memory or the like. The display unit 11 lays out, in the virtual space, the content stored in the memory or the like of the see-through glass 10. Specifically, the display unit 11 lays out the content in a preset orientation at preset position coordinates in the virtual space. The display unit 11 outputs information indicating position coordinates and an orientation of the content to the determination unit 13 and the position changing unit 14. The display unit 11 outputs information indicating a shape of the content to the determination unit 13. In an example illustrated in FIG. 2, the display unit 11 lays out content C1 on a spherical surface centered on an origin in a virtual space (hereinafter referred to as a virtual spherical surface). In this case, the display unit 11 lays out the content C1 in a preset orientation at the preset position coordinates. The content may be generated by the see-through glass 10 or may be acquired by using a method other than the above.

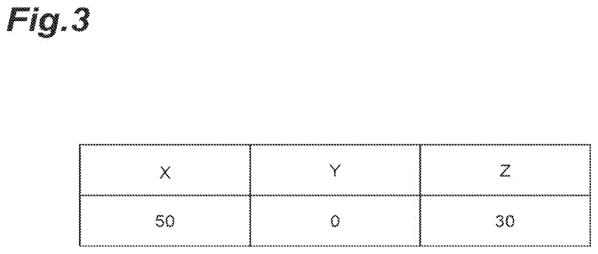

FIG. 3 illustrates an example of position coordinates of the content C1 in the virtual space. For example, a centroid of the content C1 is fixed to the position coordinates and the position coordinates are laid out in a preset orientation on the virtual spherical surface so that the content C1 is laid out in the virtual space.

Here, the content is information that is displayed in the see-through glass 10. In the present embodiment, the content indicates an object having a shape in the virtual space. For example, the content indicates a three-dimensional object such as a rectangular parallelepiped or a sphere in the virtual space. Further, for example, the content indicates a plane having a rectangular shape, a circular shape, or the like in the virtual space. As an example, the content may display a moving image, an image, or the like in the plane. The orientation in the virtual spherical surface of the content is set in advance (to be described below), and for example, in rectangular content, a rectangle may be set to be directed to an origin.

Since the position of the content may be uniquely determined in the virtual space, for example, any point included in the content may be fixed to the position coordinates. Further, since the display unit 11 only needs to be able to lay out the content around the origin in the virtual space, the display unit 11 may lay out the content on a spherical surface centered on a position other than the origin or may lay out the content on a side surface of a cylinder having a center axis passing through the origin or the like. The information indicating a shape of the content is set in advance by a provider of the content or the like. Further, the position coordinates and orientation at which the content is laid out are set in advance by the provider of the content, a user of the see-through glass 10, or the like. Further, information indicating the position coordinates and orientation of the content is managed together with the content on a database connected to the see-through glass 10, and the see-through glass 10 acquires the information indicating the position coordinates and orientation of the content together with the content from the database. Alternatively, the information indicating the position coordinates and orientation of the content may be acquired by using any of other methods.

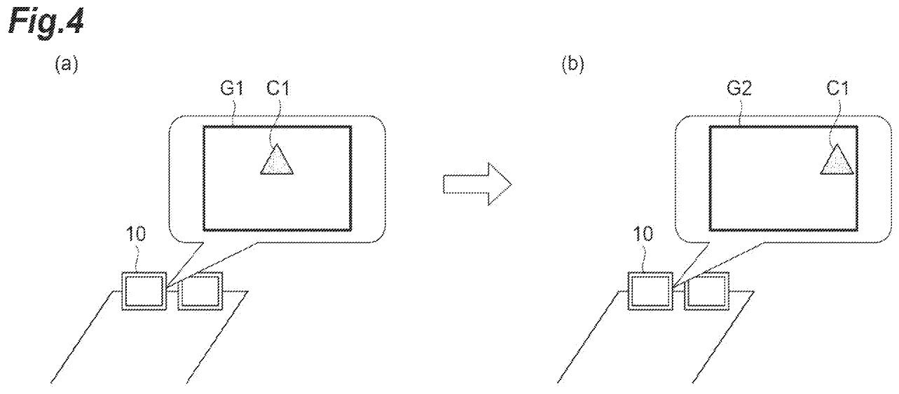

The display unit 11 displays an image of the content laid out in the virtual space as viewed from a predetermined position in the virtual space. Specifically, the display unit 11 displays to the user an image of the virtual space as viewed from a predetermined position (hereinafter referred to as a reference position of the line of sight) toward a predetermined direction (hereinafter referred to as a virtual line-of-sight direction) in the virtual space. In the example illustrated in FIG. 2, the display unit 11 sets the origin in the virtual space as the reference position of the line of sight when the see-through glass 10 is started up. The display unit 11 displays to the user an image of the virtual space as viewed from the reference position of the line of sight toward a virtual line-of-sight direction d1 in the virtual space, as illustrated in FIG. 4(a). It is possible to perform processing for displaying an image of the virtual space as viewed from a predetermined position, including laying out the content, using an existing technology. Further, the virtual line-of-sight direction becomes a preset initial direction when the see-through glass 10 has been activated. The initial direction of the virtual line-of-sight direction may be, for example, an X-axis direction in the virtual space or may be another direction other than the above. Using this processing, the display unit 11 associates the reference position of the line of sight in the virtual space in which the content is laid out with a position of the eye of the user in the real space.

The display unit 11 displays the image of the virtual space as viewed from the predetermined position, on the basis of an orientation of the see-through glass 10 in the real space. Specifically, the display unit 11 changes the virtual line-of-sight direction in the virtual space according to change in the orientation of the see-through glass 10 in the real space. As an example, first, a sensor mounted on the see-through glass 10 detects the change in orientation of the see-through glass 10 in the real space. That is, an orientation of a head portion (face) of the user on which the see-through glass 10 has been mounted is acquired by a sensor. The display unit 11 converts the change in the orientation into a change in the virtual line-of-sight direction in the virtual space. That is, the orientation of the head portion of the user in the real space is linked to the virtual line-of-sight direction in the virtual space. The display unit 11 outputs information indicating the virtual line-of-sight direction to the determination unit 13 each time the virtual line-of-sight direction is changed. The detection processing and the conversion processing can be performed using an existing technology. Since the sensor mounted on the see-through glass 10 only needs to be able to detect the change in orientation of the see-through glass 10, the sensor may be, for example, a triaxial sensor, a gyro sensor or may be any of other sensors other than the above. The sensor may be externally attached to the see-through glass 10.

With the above processing, for example, when the user moves the head portion in the real space in a direction to pay attention to or in order to view content, the virtual line-of-sight direction in the virtual space changes corresponding to the movement. Therefore, for example, the user can set a direction in which there is content to which the user wants to pay attention in the virtual space, as the virtual line-of-sight direction, by moving a neck to move the head portion in the real space. That is, the user can trace the content displayed on the see-through glass 10 in the virtual space.

In the example illustrated in FIG. 2, the display unit 11 changes the virtual line-of-sight direction from d1 to d2 on the basis of the change in orientation of the see-through glass 10 in the real space. In this case, the image displayed to the user changes from an image G1 in which the content C1 is captured at a center as illustrated in FIG. 4(a) to an image G2 in which the content C1 is captured at a right end as illustrated in FIG. 4(b).

As described above, the display unit 11 lays out the content in the virtual space, and presents to the user an image of the virtual space as viewed from the reference position of the line of sight in the virtual space, toward the virtual line-of-sight direction corresponding to the orientation of the see-through glass 10 in the real space. Here, when the display unit 11 displays the content, a person around the user may be confused. Specifically, when the user pays attention to the content displayed on the see-through glass 10 in the real space, eyes of another person may be present on the other side of the content. In such a case, the user himself or herself does not intend to view the eyes of the other person, but the other person feels as if the user views the other person. Thus, when the user uses the see-through glass 10, the line of sight of the user and a line of sight of a nearby person may overlap, making the nearby person suspicious. For example, in a train or a waiting room, when the line of sight of the user and the line of sight of the nearby person overlap through a screen displayed by the display unit 11, the nearby person may feel uncomfortable because nearby people seem to be staring at the user. In this case, it is conceivable that the user recognizes a line of sight of another person with his or her eyes and avoids the overlapping of the lines of sight. However, there is concern that the avoidance method imposes a burden on the user and impairs convenience for the user. Further, when the display control device is the non-transmissive head mounted display, the orientation of the face of the user becomes a direction of the face of the nearby person, which may make the nearby person suspicious. In this case, since the user cannot visually recognize a surrounding situation, the user cannot avoid the user being directed to the direction of the face of the nearby person.

Therefore, in order to solve the above problem, the see-through glass 10 appropriately changes the position of the content in the virtual space. When the user attempts to view the content whose position has been changed, the user orients his or her head portion toward the content. Therefore, when the position of the content is appropriately changed, the line of sight of the user or a direction of the face or the like is appropriately changed. Accordingly, the see-through glass 10 can prevent the line of sight of the user from overlapping the line of sight of the nearby person. Further, when the display control device is a non-transmissive head mounted display, it is possible to prevent the orientation of the face of the user from being the direction of the face of the nearby person in the same manner as described above. Hereinafter, functions of the detection unit 12, the determination unit 13, and the position changing unit 14 will be described in order to describe a function of appropriately changing the position of the content.

The detection unit 12 detects an orientation of at least part of a head portion of a person other than the user with respect to the see-through glass 10 (a display). Specifically, the detection unit 12 acquires an image captured by an imaging device (a camera) mounted on the see-through glass 10. The detection unit 12 detects an orientation of a line of sight of a nearby person in the acquired image as the orientation of the at least portion of the head portion of the person other than the user. The detection unit 12 outputs information indicating the detected line of sight to the determination unit 13. As an example, the imaging device mounted on the see-through glass 10 periodically captures an image in the direction of the line of sight of the user wearing the see-through glass 10 in real space, and outputs the images to the detection unit 12. In this case, the imaging device is mounted at a position that can be regarded as the position of the eyes of the user wearing the see-through glass 10. Next, the detection unit 12 detects, in an image captured by the imaging device or the like, position coordinates of an eye of a person on the image gazed by the user. The detection unit 12 may detect a thing (for example, an orientation of a face) other than the line of sight (eye) as the orientation of the at least portion of the head portion of the person other than the user. Further, the detection processing can be performed using an existing technology such as an image recognition technology. Further, the detection unit 12 may detect a plurality of orientations (lines of sight) of the at least portion of the head portion of the person other than the user. For example, when the image includes eyes of a plurality of persons, the detection unit 12 detects position coordinates of the eyes of the plurality of persons on the image.

The detection unit 12 continuously detects the orientation of the at least portion of the head portion of the person other than the user with respect to the see-through glass 10. Specifically, the imaging device mounted in the see-through glass 10 captures an image in a line-of-sight direction of the user at regular time intervals. The detection unit 12 acquires the image from the imaging device each time imaging is performed when the see-through glass 10 is activated. The detection unit 12 continues to detect an orientation of the line-of-sight of the person other than the user each time the detection unit 12 acquires the image from the imaging device. The detection unit 12 outputs the information indicating the position coordinates of the detected line of sight on the image and a capturing time of the image to the determination unit 13.

The determination unit 13 determines whether or not the position of the content needs to be changed on the basis of the result of detection in the detection unit 12 and the position of the content laid out in the virtual space. Specifically, first, the determination unit 13 receives information indicating the line of sight from the detection unit 12. The determination unit 13 receives the information indicating the virtual line-of-sight direction from the display unit 11. The determination unit 13 derives a direction to which a direction in which there is a line-of-sight of the other person when viewed from the user in the real space corresponds, when viewed from the reference position of the line of sight in the virtual space, on the basis of the information indicating the line of sight input from the detection unit 12 and the information indicating the virtual line-of-sight direction input from the display unit 11.

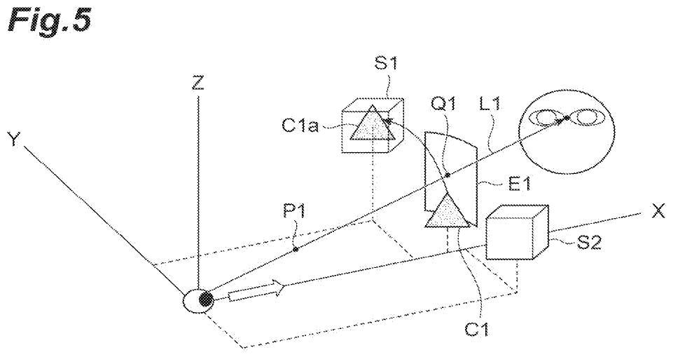

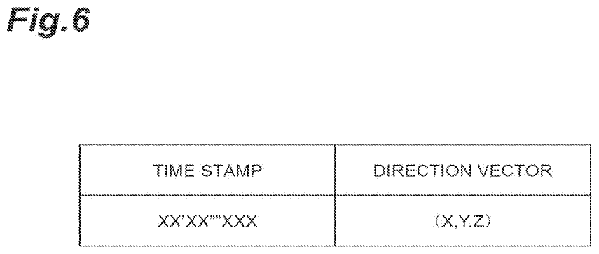

As an example, the determination unit 13 receives, as the information indicating the line of sight, the information indicating the position coordinates of the line of sight on the image and the capturing time of the image from the detection unit 12. The determination unit 13 receives the virtual line-of-sight direction at the time of capturing the image from the display unit 11. Here, it is assumed that the virtual line-of-sight direction and the reference position of the line of sight in the virtual space correspond to the direction of the line of sight of the user (a capturing direction of the image) and the position of the eye of the user (a position of the imaging device) when the image is captured, respectively. The determination unit 13 converts the position coordinates of the line of sight on the image into position coordinates P1 in the virtual space illustrated in FIG. 5 on the basis of the correspondence relationship. The determination unit 13 derives a straight line L1 passing through the position coordinates P1 after the conversion and the reference position of the line of sight. The determination unit 13 derives a direction vector of the straight line L1. The determination unit 13 uses a time (time stamp) at which the line of sight is detected (for example, an imaging time) and the direction vector in the virtual space as direction information as illustrated in FIG. 6. That is, the determination unit 13 records information indicating a line-of-sight detection time and information indicating the direction vector. Here, the above conversion processing is performed using an existing technology.

The position coordinates P1 in the above processing is a point in the virtual space that corresponds to a point located in a direction in which there is a position of an eye of a nearby person when viewed from the position of the eye of the user in the real space. Further, when the conversion processing and the derivation processing is performed, the direction vector in the virtual space becomes a direction vector corresponding to a direction in which there is a line of sight of the other person when viewed from the position of the eye of the user in the real space. That is, a direction of the see-through glass 10 which is the direction of the line of sight of the user in the real space when the line of sight is detected by the detection unit 12 corresponds to the virtual line-of-sight direction. This makes it possible for the determination unit 13 to specify a direction in which there is the line of sight of the other person when viewed from the reference position of the line of sight in the virtual space in which the content is laid out. The determination unit 13 performs the above processing on each line of sight of the other person detected by the detection unit 12.

Next, the determination unit 13 sets an avoidance region (avoidance frame guide) on the basis of the derived direction. The determination unit 13 outputs information indicating the avoidance region to the position changing unit 14. In the example illustrated in FIG. 2, the determination unit 13 derives the straight line L1 passing through the reference position of the line of sight and parallel to the derived direction vector on the basis of the direction vector. The determination unit 13 sets, as an intersection Q1, a point in a direction indicated by the direction vector when viewed from the reference position of the line of sight between two intersections between the straight line L1 and the virtual spherical surface. The determination unit 13 sets an avoidance region E1 with an intersection Q1 as a reference. The avoidance region is set so that the orientation of the line of sight of the user sufficiently changes when the content is moved to a position that does not overlap the avoidance region in the image of the virtual space as viewed from the reference position of the line of sight and is set so that overlapping between the line of sight of the user and the line of sight of the nearby person can be avoided. That is, when the line of sight of the user overlaps that of the other person, the determination unit 13 sets a range having a constant buffer value from the intersection Q1 or the like in the virtual space as an avoidance region since a range in which the user is considered to gave is not a point. Further, for example, the avoidance region may be a circle with the intersection Q1 or the like as a center on the virtual spherical surface, may be a rectangle with the intersection Q1 or the like as a centroid, or may have a shape other than those described above with a point other than the above points as a reference.

Finally, the determination unit 13 determines whether or not the content is located at a position at which the nearby person is confused, on the basis of the derived avoidance region, and the information indicating the position coordinates of the content and the shape of the content acquired from the display unit 11. As an example, the determination unit 13 determines that the position of the content is to be changed when the avoidance region overlaps the content when viewed from the reference position of the line of sight, on the basis of the information indicating the position coordinates of the content and the information indicating the shape of the content input from the display unit 11. When the user views the content that overlaps the avoidance region, the line of sight of the user and the line of sight of another person overlap. The determination unit 13 notifies the position changing unit 14 of the determination indicating that the position of the content is to be changed. That is, the determination unit 13 determines whether or not the content is displayed on a straight line passing through the position of the eye of the user and the position of the eye of the nearby person in the real space.

The determination unit 13 may determine whether or not the position of the content needs to be changed on the basis of temporal change in the at least portion of the head portion of the person other than the user detected by the detection unit 12. That is, the determination unit 13 determines whether or not the position of the content needs to be changed according to a line-of-sight detection time. Specifically, when the set avoidance region and the content overlap when viewed from the reference position of the line of sight, the determination unit 13 may determine that the position of the content is to be changed when a line of sight corresponding to the avoidance region continues to be detected for a certain period of time within a predetermined range. On the other hand, the determination unit 13 may determine that the position of the content is not to be changed when the line of sight moves to the outside of the predetermined range or when the line of sight is not detected before a certain period of time elapses. As an example, the determination unit 13 determines whether or not the set avoidance region and the content overlap when viewed from the reference position of the line of sight. When the determination unit 13 determines that the set avoidance region and the content overlap, the determination unit 13 generates a predetermined range from a point that serves as a reference of the avoidance region. The determination unit 13 determines that the position of the content is to be changed when a position of an intersection between the direction in which the line of sight is located and the virtual spherical surface transitions within the predetermined range for a certain period of time after the line of sight corresponding to the avoidance region is detected (the detected position of the line of sight does not dynamically show a certain change). The determination unit 13 notifies the position changing unit 14 of the determination indicating that the position of the content is to be changed. That is, the determination unit 13 determines that the position of the content is to be changed in the virtual space when detection of the line of sight of the other user overlapping the content continues for a certain period of time with respect to the direction of the line of sight of the user in the real space. After the line of sight is detected by the detection unit 12, the determination unit 13 determines whether or not the content is displayed for a certain period of time on the straight line passing through the position of the eye of the user and the position of the eye of the nearby person in the real space on the basis of a motion of the detected position of the line of sight, to determine whether the position of the content needs to be changed (overlapping of the line of sight needs to be avoided), and determines whether the position of the content needs to be changed. The certain period of time may be measured with an actual time as a reference, may be measured with the number of times the information indicating the line of sight is acquired from the detection unit 12 as a reference, or may be measured with a thing other than the above as a reference.

The predetermined range is a range of change in a position of the line of sight of the nearby person when it is estimated that the nearby person is in a state of confusion when the user gazes. Specifically, the predetermined range is a range of change in position of the line of sight of the person when it is estimated that the position of the line of sight does not move when viewed from the user. As an example, when the person around the user is sitting on a seat or the like and the line of sight of the user overlaps the line of sight of the person, the position of the content needs to be changed in order to avoid the overlap of the lines of sight. In the above case, the predetermined range is set so that at least the position change range of the line of sight of the nearby person can be included. Further, when the person around the user is moving and the position of the line of sight of the person changes greatly over time when viewed from the user, the line of sight of the user and the line of sight of the person no longer overlap after a certain period of time without changing the position of the content.

When the determination unit 13 determines that the position of the content is to be changed, the position changing unit 14 sets the position change destination of the content in the virtual space on the basis of a distance between the position change destination of the content and a position at a current point in time of the content in the virtual space (hereinafter referred to as a movement distance), and changes the position of the content. Specifically, the position changing unit 14 receives notification of the determination indicating that the position of the content is to be changed from the determination unit 13. The position changing unit 14 receives the information indicating the position coordinates and orientation of the content from the display unit 11. The position changing unit 14 receives the information indicating the avoidance region from the determination unit 13. The position changing unit 14 sets the position change destination whose movement distance is a predetermined distance on the virtual spherical surface of the virtual space as the position change destination of the content on the basis of the position coordinates of the content. The position changing unit 14 changes the position of the content to the set position change destination.

As an example, in the example illustrated in FIG. 5, the position changing unit 14 sets a position change destination of the content C1 to the position change destination C1a which is located in a preset direction from a position at the current point in time of the content C1 and to which the movement distance is a distance allowing at least movement to the outside of the avoidance region E1. That is, the position changing unit 14 sets the position change destination of the content in the virtual space when the determination unit 13 determines that the position of the content needs to be changed. That is, the position changing unit 14 controls the position of the content displayed by the display unit 11 when the determination unit 13 determines that the position of the content needs to be changed. Since the outer side of the avoidance region only needs to be the position change destination when the content is moved, a direction in which the content is moved may be, for example, a horizontal direction, a vertical direction, or an oblique direction when viewed from the reference position of the line of sight or in other directions. Further, the direction in which the content is moved may be a direction from the reference point of the avoidance region to a centroid of the content. The content moves on a spherical surface with the reference position of the line of sight as a center. Further, the predetermined distance is at least a distance allowing the content whose position is to be changed to move outside a range of the avoidance region set by the determination unit 13, and may be set in advance, for example, according to a size of the avoidance region as a reference or may be set in advance according to any of other references. The position change direction of the content and the priority of the position change direction are set in advance in the see-through glass 10.

The position changing unit 14 may also set the position change destination of the content also on the basis of a detection result by the detection unit 12. Specifically, in a case in which the determination unit 13 notifies the position changing unit 14 of the determination indicating that the position of the content is to be changed, when the detection unit 12 detects a line of sight other than the line of sight overlapping the content (when the detection unit 12 detects a plurality of lines of sight), the position changing unit 14 sets the position change destination of the content on the basis of a detection result. As an example, the position changing unit 14 acquires, from the determination unit 13, information indicating an avoidance region other than the avoidance region that overlaps the content when the position changing unit 14 receives a notification indicating that the position of the content is to be changed, from the determination unit 13. The position changing unit 14 sets the avoidance region as a prohibited region. The position changing unit 14 sets the position change destination of the content according to a preset movement distance and direction. Here, when an occupied region (to be described below) of the content and the prohibited region overlap when viewed from the reference position (the user) of the line of sight at the set position change destination, the position changing unit 14 sets the next position change destination according to a priority of the movement distance or direction. The position changing unit 14 repeats the above processing until an appropriate position change destination is determined. Thus, in the image of the virtual space as viewed from the reference position of the line of sight, a position change destination at which an occupied region (to be described below) of the content whose position is to be changed does not overlap the prohibited region is set as the position change destination of the content. That is, the position changing unit 14 searches for a region (empty space) in which the content can be laid out on the virtual spherical surface, and sets a position change destination in which the occupied region of the content whose position is changed is contained and to which the movement distance is a predetermined distance, as the position change destination of the content.

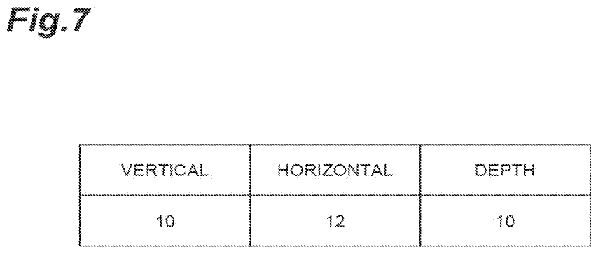

The position changing unit 14 may set the position change destination of the content on the basis of a position of content other than the content whose position is to be changed in the virtual space. Specifically, first, when the position changing unit 14 receives the notification indicating that the position of the content is to be changed from the determination unit 13, the position changing unit 14 sets an occupied region (a parameter of a size of the content) (a size of the content) for the content laid out in the virtual space. In FIG. 7, an example of information indicating an occupied region of the content C1 in the virtual space is illustrated. Here, the occupied region of the content indicates a plane or solid (hereinafter referred to as an occupied region) including the content in the virtual space. The vertical, horizontal, and depth in the information mean, for example, lengths of three sides of a rectangular parallelepiped when the occupied region is represented by the rectangular parallelepiped. The position changing unit 14 sets the occupied region of the content in the virtual space on the basis of the information indicating the occupied region of the content.

As an example, as illustrated in FIG. 7, information indicating an occupied region S1 of the content C1 is stored in advance. The position changing unit 14 generates, for example, a rectangle having a vertical length of a bottom surface of 10, a horizontal length of the bottom surface of 12, and a height (depth) of 10 as the occupied region S1 of the content C1 illustrated in FIG. 7 from the information indicating the occupied region S1. As illustrated in FIG. 2, the position changing unit 14 lays out a rectangular parallelepiped (the occupied region S1) such that the centroid of the content C1 matches a centroid of the rectangular parallelepiped. In such a case, the position changing unit 14 associates an orientation of the rectangular parallelepiped in the virtual space with an orientation of the content C1 in advance. Further, the occupied region of the content may not be a rectangular parallelepiped, may be, for example, a sphere or a cone, or may be a shape other than the above. Alternatively, the occupied region of the content may be the shape of the content itself. Further, when the position of the content is to be changed (which will be described below), a position and angle of the occupied region are changed in correspondence to the change in the position and angle of the content. Further, a size of the occupied region of the content is set in advance according to the shape of the content by the position changing unit 14 or the like. The occupied region may represent a region occupied by the content in the virtual space. The occupied regions may be set so that content corresponding to the respective occupied regions do not overlap each other when the occupied regions do not overlap each other when viewed from the reference position of the line of sight. For example, the occupied region needs not be excessively larger than the content.

The position changing unit 14 sets an occupied region of the content other than the content whose position is to be changed in the virtual space, as the prohibited region. The position changing unit 14 sets a position change destination at which the occupied region of the content whose position is to be changed does not overlap the prohibited region in the image of the virtual space as viewed from the reference position of the line of sight, as the position change destination of the content, in the same manner as described above. That is, when there are a plurality of pieces of content in the virtual space, the content is moved outside the avoidance region, but when there is content in surroundings, a position at which the occupied region of the content is most contained is calculated and the content is laid out again. A case in which the position change destination cannot be set as a result of repeating the above processing will be described below. The position changing unit 14 sets the prohibited region so that a region in which the content is displayed on the see-through glass 10 in the real space does not lie on the straight line passing through the position of the eye of the user and the position of the eye of the nearby person in the real space.

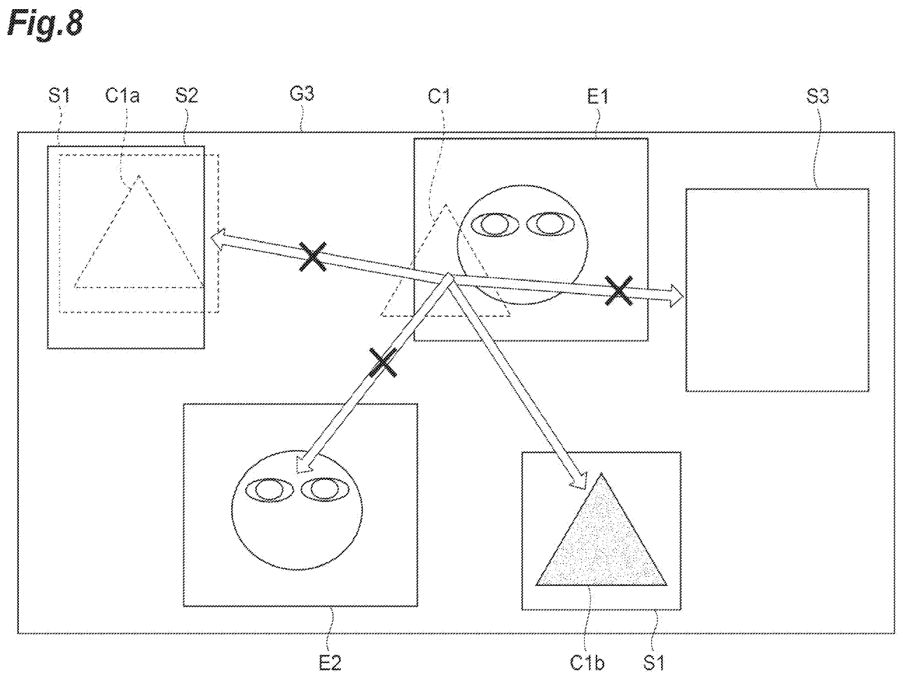

FIG. 8 is a diagram illustrating control of the position change destination of the content C1 when the occupied region S1 of the content C1 and the prohibited region overlap in the position change destination C1a of the content. In FIG. 8, an image G3 of the virtual space as viewed from the reference position of the line of sight toward the virtual line-of-sight direction, is illustrated. In the example illustrated in FIG. 8, when the determination unit 13 notifies the position changing unit 14 of the determination indicating that the position of the content C1 is to be changed, the position changing unit 14 sets an avoidance region E2 derived by the determination unit 13 as the prohibited region. Further, in the above case, the position changing unit 14 sets an occupied region S2 of content C2 as a prohibited region and sets an occupied region S3 of the content C3 as a prohibited region, for the content C2 and C3 that are content other than the content C1 whose position is to be changed. Here, since the position change destination C1a overlap the occupied region S2, which is a prohibited region, the position changing unit 14 sets a position change destination C1b which is located in another direction set in advance from the position at a current point in time of the content C1 and to which the movement distance is a predetermined distance, as the position change destination of the content C1. When another prohibited region overlaps the occupied region S1 of the content C1 at the position change destination C1b, the position changing unit 14 sets the position change destination located in a preset yet another direction, as the position change destination of the content C1. In this case, the position change direction of the content and the priority of the position change direction are set in advance.

When the position change destination to which a movement distance of the content whose position is to be changed becomes the predetermined distance is not appropriate as the position change destination, the position changing unit 14 may set a position at which the movement distance is close to the predetermined distance as the position change destination. Specifically, when the occupied region of the content overlaps the prohibited region irrespective of a direction in which the position is changed, in the position change destination to which the movement distance is a predetermined distance, the position changing unit 14 may set a position to which the movement distance becomes smaller than a predetermined distance until the occupied region of the moving content does not overlap the prohibited region, as the position change destination of the content. When the prohibited region is present at the position change destination of the content, the position changing unit 14 sets a position to which the movement distance is increased until the occupied region of the moving content does not overlap the prohibited region, in the position change direction, as the position change destination of the content. Here, it is assumed that the position change destination to which the movement distance is small is a position close to a region in which the content was originally displayed in a display region of the see-through glass 10 in the real space, which is a position at which a region centered on the straight line passing through the position of the eye of the user and the position of the eye of the nearby person, or a region in which other content is displayed is not encroached. The position change destination is a position suitable for moving the display position of the content. The position change destination is set as the position change destination of the content, making it possible to prevent the line of sight of the user from overlapping the line of sight of the nearby person and to reduce the change in the orientation of the line of sight of the user. When the movement distance changes from the predetermined distance, it is not always necessary to change a movement direction as described above, and the movement distance may change from the predetermined distance in one movement direction set in advance.

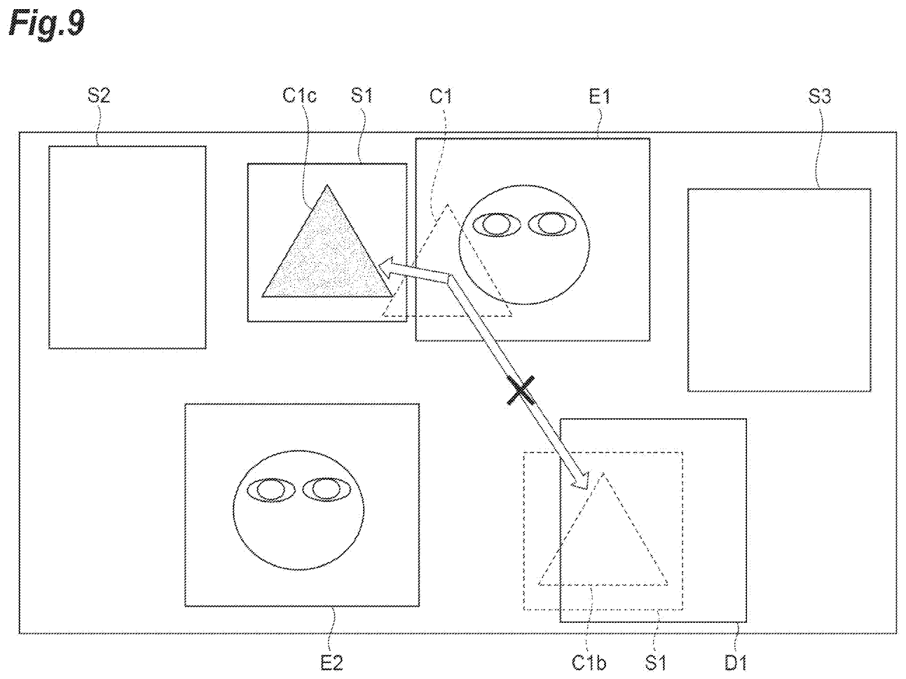

FIG. 9 is a diagram illustrating control of the position change destination of the content C1 when the occupied region S1 of the content C1 overlaps a prohibited region D1 at the position change destination C1b of the content. In FIG. 9, an image G4 of the virtual space as viewed from the reference position of the line of sight toward the virtual line-of-sight direction, is illustrated. As illustrated in FIG. 9, the position changing unit 14 sets, as the position change destination of the content C1, a position change destination C1c whose movement distance is smaller than a predetermined distance and at which the occupied region S1 of the content C1 does not overlap the avoidance region and the prohibited region when the prohibited region D1 is present in a region that is the position change destination C1b and another prohibited region is present in a region above the avoidance region. In such a case, the direction of the position change destination is selected according to the preset priority described above. For example, in the above-described example, a direction in which the priority of the position change destination is highest is a direction in which the position change destinations C1a and C1c are located.

In the position changing processing described above, when the position changing unit 14 changes the position of the content, the position changing unit 14 changes the position of the content on the virtual spherical surface that is a spherical surface with the reference position of the line of sight as a center. Therefore, when the determination unit 13 determines that the position of the content is to be changed, the position changing unit 14 sets the position change destination of the content and changes the position of the content so that a distance between the position of the content and the predetermined position in the virtual space is kept constant. When the content is laid out on a side surface of a cylinder centered on a straight line passing through the reference position of the line of sight, the position of the content is changed so that a distance between the reference position of the line of sight and the position of the content is kept constant. For example, the position of the content is changed at a line of intersection between a plane on which there is the content and which is perpendicular to a central axis of the cylinder and a side surface of the cylinder.

Further, in the position change processing, when the position change destination of the content is not present anywhere on the virtual spherical surface, the position changing unit 14 sets a position to which the movement distance becomes a predetermined distance as the position change destination of the content while performing the following processing. For example, in the above case, the position changing unit 14 may perform processing for exchanging the position of the content with that of the other content. In this case, when the occupied region of the other content overlaps the occupied region of the content at the position change destination of the content, the position changing unit 14 moves the other content to the position at the current point in time of the content. When the movement is performed, the other content may overlap the avoidance region and the occupied region after the movement, a size of the other content may be reduced so that the other content does not overlap, or other processing may be performed on the content so that the other content does not overlap.

Further, in the above case, the position changing unit 14 may perform processing for creating a position change destination of the other content by moving the other content. As an example, the position changing unit 14 radially moves the other content in an orientation away from a center point of the image of the virtual space as viewed from the reference position of the line of sight. Further, in the above case, the position changing unit 14 may perform processing for setting the position at which the content overlaps the occupied region of the other content as the position change destination of the content. In this case, when the line of sight within the avoidance region is no longer detected, the position changing unit 14 moves the content to the position before the position change.

The position changing unit 14 changes the position of the content to the set position change destination through the above position change processing. The position changing unit 14 outputs information indicating the position change destination of the content to the display unit 11. The display unit 11 receives the information indicating the position change destination of the content from the position changing unit 14, and displays on the display an image of the virtual space in which the position of the content has been changed, as viewed from the reference position of the line of sight toward the virtual line-of-sight direction in the virtual space. That is, the display unit 11 displays the content while avoiding overlapping between the line of sight detected by the detection unit 12 and the line of sight of the user. Further, the display unit 11 re-displays the content at the display position change destination of the content.

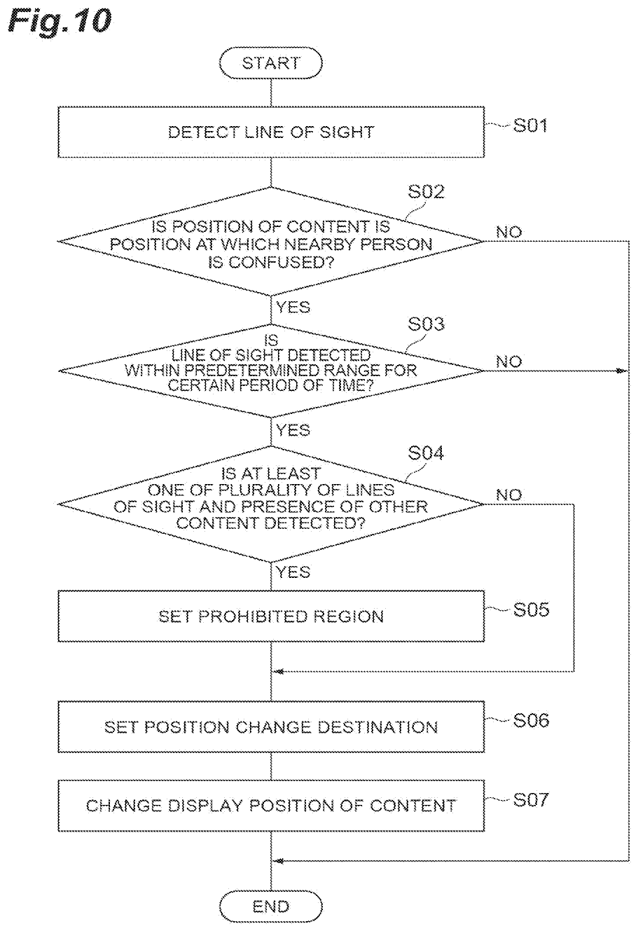

Subsequently, processing executed by the see-through glass 10 according to the present embodiment (an operation method performed by the see-through glass 10) will be described using the flowchart of FIG. 10. The present processing is processing when the see-through glass 10 is used by the user. First, at a point in time of the start of the present processing, the display unit 11 has already displayed to the user the image the virtual space as viewed from the reference position of the line of sight toward the virtual line-of-sight direction in the virtual space. As shown in the flowchart of FIG. 10, in this processing, the detection unit 12 detects, continuously over time, the orientation of the at least portion of the head portion of the person other than the user with respect to the see-through glass 10 (S01). Subsequently, the determination unit 13 determines whether or not the position of the content is the position at which the nearby person is confused, on the basis of a detection result by the detection unit 12 and the position of the content in the virtual space (S02). When a determination is made that the position of the content is the position at which the nearby person is confused (YES in S02), the determination unit 13 determines whether or not the line of sight detected by the detection unit 12 continues to be detected within a predetermined range for a certain period of time (S03). When a determination is made that the position of the content is not the position at which the nearby person is confused (NO in S02) or when the line of sight detected by the detection unit 12 is no longer detected within a predetermined range (NO in S03), the processing ends.

When the determination unit 13 determines that the line of sight detected by the detection unit 12 continues to be detected within the predetermined range for the certain period of time (YES in S03), the position changing unit 14 determines whether or not at least one of a condition that a plurality of lines of sight is detected by the detection unit 12 and a condition that there is content other than the content whose position is to be changed in the virtual space is satisfied (S04). When the position changing unit 14 determines that at least one of the above conditions is satisfied (YES in S04), the position changing unit 14 sets the prohibited region on the basis of the detection result by the detection unit 12 or a position of the content other than the content whose position is to be changed (S05). Subsequently, when step S05 is executed or when the position changing unit 14 determines that at least one of the above conditions is not satisfied (NO in S04), the position changing unit 14 sets the position change destination of the content on the basis of the movement distance of the content (S06). Subsequently, the position of the content is changed by the position changing unit 14 (S07).

In the present embodiment, the position changing unit 14 sets the position change destination of the content on the basis of a distance between the position change destination of the content and the position at the current point in time in the virtual space, and changes the position of the content. With such a configuration, for example, a position whose distance from a current point in time is a preset predetermined distance is set as the position change destination of the content. Here, the predetermined distance is set such that the orientation of the line of sight of the user sufficiently changes for avoidance of overlapping between the line of sight of the user and the line of sight of the nearby person, and the orientation of the line of sight of the user does not change excessively. This makes it possible to prevent the line of sight of the user from overlapping the line of sight of the nearby person, and to prevent the nearby person from being suspicious due to a movement of the user for changing the line of sight. Thus, in the present embodiment, it is possible to prevent the person around the user from being confused.

Further, as in the embodiment, the position changing unit 14 may set the position change destination of the content also on the basis of the detection result by the detection unit 12. According to such a configuration, for example, the position change destination of the content is set so that the avoidance region and the prohibited region, which are regions in which there is the line of sight of the nearby person, do not overlap the content when viewed from the reference position of the line of sight. This makes it possible to more reliably prevent the line of sight of the user from overlapping the line of sight of the nearby person. Therefore, it is possible to more reliably prevent the person around the user from being confused. However, it is not always necessary to set the position change destination of the content as described above.

Further, as in the present embodiment, the position changing unit 14 may set the position change destination of the content on the basis of the position of the content other than the content whose position is to be changed in the virtual space. With such a configuration, for example, the position change destination of the content is set so that the prohibited region that is a region in which other content has already been displayed does not overlap the content when viewed from the user. This makes it possible to more reliably prevent the line of sight of the user from overlapping the line of sight of the nearby person while preventing the content from being displayed in an overlapping manner. Therefore, it is possible to more reliably prevent the person around the user from being confused without impairing convenience for the user. However, it is not always necessary to set the position change destination of the content as described above.

Further, as in the present embodiment, the detection unit 12 may continue to continuously detect the orientation of the at least portion of the head portion of the person other than the user, the orientation being an orientation with respect to the see-through glass 10, and the determination unit 13 may determine whether or not the position of the content needs to be changed on the basis of the temporal change in at least portion of the head portion of the person other than the user detected by the detection unit 12. With such a configuration, when the detection unit 12 continuously detects the at least portion of the head portion of the person other than the user for a predetermined period of time and the change in the position of the detected line of sight is within the predetermined range, the determination unit 13 determines that the position of the content is to be changed. For example, it is determined whether or not the position of the content needs to be changed on the basis of a position of a line of sight of only a person who does not have a large change in the position of the line of sight viewed from the user among nearby persons. This makes it possible to more reliably prevent the line of sight of the user from overlapping the line of sight of the nearby person. Therefore, it is possible to more reliably prevent the person around the user from being confused. Further, when such a configuration is adopted, it is determined that the position of the content is not to be changed even in a case in which the position of the line of sight of the person and the content overlap when viewed from the reference position of the line of sight, for example, when the position of the line of sight greatly moves among the nearby persons. That is, the position of the content whose position does not need to be changed when viewed from the user is not changed. Accordingly, since the change is performed only when the position of the content needs to be changed, convenience for the user is ensured. That is, an excessive frequency of position change (fluttering of display) is avoided. However, it is not always necessary to determine whether or not the position of the content needs to be changed, as described above.

Further, as in the present embodiment, when the determination unit 13 determines that the position of the content is to be changed, the position changing unit 14 may set the position change destination of the content to set the position of the content so that a distance between the position of the content in the virtual space and the reference position of the line of sight that is a viewpoint of the image displayed on the see-through glass 10 is kept constant. Accordingly, before and after changing of the position of the content, resolution of the content and a size of the content viewed from the reference position of the line of sight do not change. Therefore, it is possible to more reliably prevent the person around the user from being confused without impairing convenience for the user. However, it is not always necessary to set the position change destination of the content as described above.

The display control device may include devices other than the see-through glass 10. Specifically, the see-through glass 10 and the other devices are display control devices. A function of displaying an input image is mounted in the see-through glass 10, and some of functions of the see-through glass 10 other than the above function may be mounted on another device connected to the see-through glass 10 by a cable or wirelessly. As an example, the see-through glass 10 is connected to a server via a communication line, and the see-through glass 10 transmits information obtained from the imaging device and the sensor to the server. The display unit 11, the detection unit 12, the determination unit 13, and the position changing unit 14 of the server appropriately control the position of the content in the virtual space. Further, using a communication function of the server, an image of the virtual space as viewed from the reference position of the line of sight in the virtual space toward the virtual line-of-sight direction is transmitted to the see-through glass 10. Finally, the see-through glass 10 display the received image on the display. Some of the functions of the see-through glass 10 may be installed in a PC, a smartphone, or the like instead of the server, or may be mounted in another terminal other than the above. Further, some of the functions of the see-through glass 10 may be divided and mounted in a plurality of devices other than the see-through glass 10.

In the above-described embodiment, a case in which the display control device is the see-through glass 10 having a display function has been described, but the see-through glass 10 does not necessarily have the display function. The display control device may be a display that displays an image of the content laid out in the virtual space as viewed from a predetermined position, and may be a device (system) that controls a display of the display that the user wears on an eye portion, and may include the detection unit 12, the determination unit 13, and the position changing unit 14.

The block diagram used in the description of the embodiment shows blocks on a per-function basis. These functional blocks (components) are realized by at least any one combination of hardware and software. Further, a method of realizing the respective functional blocks is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but the present disclosure is not limited thereto. For example, a functional block (component) that causes transmission to function is called a transmitting unit or transmitter. In either case, as described above, a realization method is not particularly limited.

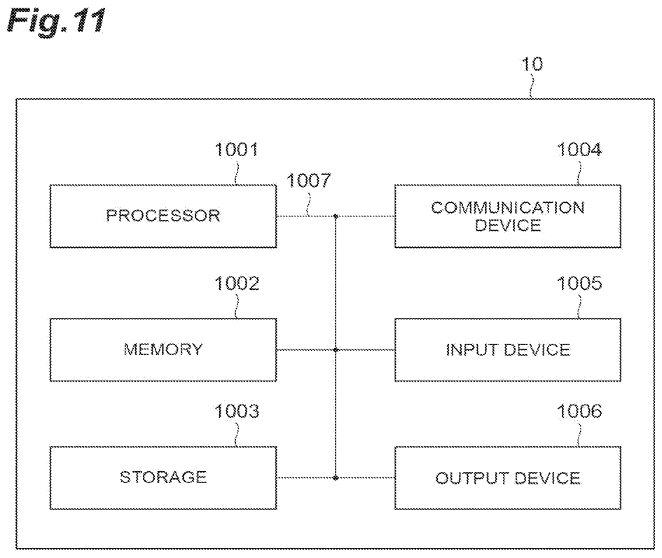

For example, the see-through glass 10 in an embodiment of the present disclosure may function as a computer that performs information processing in the present disclosure. FIG. 11 is a diagram illustrating an example of a hardware configuration of a server and client terminals according to an embodiment of the present disclosure. The see-through glass 10 described above may be physically configured as a computer device including a processor 1001, a memory 1002, a storage 1003, a communication device 1004, an input device 1005, an output device 1006, a bus 1007, and the like.

In the following description, the term “device” can be read as a circuit, a device, a unit, or the like. A hardware configuration of the see-through glass 10 may be configured to include one or a plurality of devices illustrated in FIG. 11, or may be configured not to include some of the devices.

Each function of the see-through glass 10 is realized by loading predetermined software (a program) into hardware such as the processor 1001 or the memory 1002 so that the processor 1001 performs calculation to control communication that is performed by the communication device 1004 or control at least one of reading and writing of data in the memory 1002 and the storage 1003.

The processor 1001, for example, operates an operating system to control the entire computer. The processor 1001 may be configured of a central processing unit (CPU) including an interface with a peripheral device, a control device, a calculation device, a register, and the like. For example, the above-described display unit 11 and the like may be realized by the processor 1001.

Further, the processor 1001 reads a program (program code), a software module, or data from at least one of the storage 1003 and the communication device 1004 into the memory 1002 and executes various processes according to the program, the software module, or the data. As the program, a program for causing the computer to execute at least some of the operations described in the above embodiment may be used. For example, the display unit 11 of the see-through glass 10 may be realized by a control program stored in the memory 1002 and operated in the processor 1001, and other functional blocks may be similarly realized. Although the case in which the various processes described above are executed by one processor 1001 has been described, the processes may be executed simultaneously or sequentially by two or more processors 1001. The processor 1001 may be implemented by one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store an executable program (program code), a software module, or the like that can be executed to perform information processing according to an embodiment of the present disclosure.

The storage 1003 is a computer-readable recording medium and may be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The above-described storage medium may be, for example, a database including at least one of the memory 1002 and the storage 1003, a server, or any other appropriate medium.

The communication device 1004 is hardware (a transmission and reception device) for performing communication between computers via at least one of a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, each device such as the processor 1001 and the memory 1002 is connected by the bus 1007 for communicating information. The bus 1007 may be configured by using a single bus, or may be configured by using a different bus for each device.

Further, the see-through glass 10 may include hardware such as a microprocessor, a digital signal processor (DSP), an application specific integrated circuit (ASIC), a programmable logic device (PLD), and a field programmable gate array (FPGA), and some or all of respective functional blocks may be realized by the hardware. For example, the processor 1001 may be implemented using at least one of these pieces of hardware.

A process procedure, a sequence, a flowchart, and the like in each aspect/embodiment described in the present disclosure may be in a different order unless inconsistency arises. For example, for the method described in the present disclosure, elements of various steps are presented in an exemplary order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to being made explicitly, and may be made implicitly (for example, a notification of the predetermined information is not made).

Although the present disclosure has been described above in detail, it is obvious to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for exemplification, and does not have any restrictive meaning with respect to the present disclosure.

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless of whether the software may be called software, firmware, middleware, microcode, or hardware description language or called another name.

Further, software, instructions, information, and the like may be transmitted and received via a transmission medium. For example, when software is transmitted from a website, a server, or another remote source using at least one of a wired technology (a coaxial cable, an optical fiber cable, a twisted pair, a digital subscriber line (DSL), and the like) and a wireless technology (infrared rays, microwaves, and the like), the at least one of the wired technology and the wireless technology is included in the definition of the transmission medium.

The terms “system” and “network” used in the present disclosure are used interchangeably.

Further, information, parameters, and the like described in the present disclosure may be represented by an absolute value, may be represented by a relative value from a predetermined value, or may be represented by corresponding different information.

The term “determining” used in the present disclosure may include a variety of operations. The “determining” can include, for example, regarding judging, calculating, computing, processing, deriving, investigating, looking up (search or inquiry; for example, looking up in a table, a database, or another data structure), or ascertaining as “determining”. Further, “determining” can include regarding receiving (for example, receiving information), transmitting (for example, transmitting information), inputting, outputting, or accessing (for example, accessing data in a memory) as “determining”. Further, “determining” can include regarding resolving, selecting, choosing, establishing, comparing, or the like as “determining”. That is, “determining” can include regarding a certain operation as “determining”. Further, “determination” may be read as “assuming”, “expecting”, “considering”, or the like.

The description “based on” used in the present disclosure does not mean “based only on” unless otherwise noted. In other words, the description “based on” means both of “based only on” and “at least based on”.

When “include”, “including” and variations thereof are used in the present disclosure, those teens are intended to be comprehensive like the term “comprising”. Further, the term “or” used in the present disclosure is intended not to be an exclusive OR.

### REFERENCE SIGNS LIST

10 See-through glass (display) (display control device)
11 Display unit
12 Detection unit
13 Determination unit
14 Position changing unit
1001 Processor
1002 Memory
1003 Storage
1004 Communication device
1005 Input device
1006 Output device

1. A display control device for performing control on a display of a display configured to display an image of content laid out in a virtual space as viewed from a predetermined position, the display being mounted on portions of eyes by a user, the display control device comprising circuitry configured to:
detect an orientation of at least a portion of a head portion of a person other than the user, the orientation being an orientation with respect to the display;
determine whether or not a position of the content needs to be changed on the basis of a detection-result and the position of the content laid out in the virtual space; and
set a position change destination of the content in the virtual space on the basis of a distance between the position change destination of the content in the virtual space and a position at a current point in time of the content and change the position of the content when the circuitry determines that the position of the content is to be changed.

2. The display control device according to claim 1, wherein the circuitry sets the position change destination of the content also on the basis of the detection result.

3. The display control device according to claim 1 or 2, wherein the circuitry sets the position change destination of the content also on the basis of a position of the content other than the content whose position is to be changed in the virtual space.

4. The display control device according to claim 1,
wherein the circuitry continuously detects the orientation of the at least portion of the head portion of the person other than the user, the orientation being an orientation with respect to the display, and
the circuitry determines whether or not the position of the content needs to be changed, on the basis of temporal change in at least portion of the head portion of the person other than the user.

5. The display control device according to claim 1, wherein the circuitry sets the position change destination of the content and changes the position of the content so that the distance between the position of the content and the predetermined position in the virtual space is kept constant when the circuitry determines that the position of the content is to be changed.

6. The display control device according to claim 2, wherein the circuitry sets the position change destination of the content also on the basis of a position of the content other than the content whose position is to be changed in the virtual space.

7. The display control device according to claim 2,
wherein the circuitry continuously detects the orientation of the at least portion of the head portion of the person other than the user, the orientation being an orientation with respect to the display, and
the circuitry determines whether or not the position of the content needs to be changed, on the basis of temporal change in at least portion of the head portion of the person other than the user.

8. The display control device according to claim 2, wherein the circuitry sets the position change destination of the content and changes the position of the content so that the distance between the position of the content and the predetermined position in the virtual space is kept constant when the circuitry determines that the position of the content is to be changed.

9. The display control device according to claim 3,
wherein the circuitry continuously detects the orientation of the at least portion of the head portion of the person other than the user, the orientation being an orientation with respect to the display, and
the circuitry determines whether or not the position of the content needs to be changed, on the basis of temporal change in at least portion of the head portion of the person other than the user.

10. The display control device according to claim 3, wherein the circuitry sets the position change destination of the content and changes the position of the content so that the distance between the position of the content and the predetermined position in the virtual space is kept constant when the circuitry determines that the position of the content is to be changed.

11. The display control device according to claim 4, wherein the circuitry sets the position change destination of the content and changes the position of the content so that the distance between the position of the content and the predetermined position in the virtual space is kept constant when the circuitry determines that the position of the content is to be changed.
